(19) United States
(12) Patent Application Publication
(10) Pub. No.: US 2009/0135224 A1
(43) Pub. Date: May 28, 2009

(54) LIQUID DISCHARGER AND METHOD FOR CONTROLLING THE SAME

(75) Inventors: Yuji Yakura, Kanagawa (JP); Takanori Takahashi, Kanagawa (JP); Hiroshi Udagawa, Tokyo (JP); Hiromitsu Takeda, Tokyo (JP); Toshiki Kagami, Tokyo (JP); Shinichi Horii, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: Sony Corporation, Tokyo (JP)

(21) Appl. No.: 12/127,253

(22) Filed: May 27, 2008

Related U.S. Application Data
(62) Division of application No. 11/056,656, filed on Feb. 11, 2005.

(30) Foreign Application Priority Data
Feb. 16, 2004 (JP) 2004-037604

(51) Int. Cl. B41J 2/165

(52) U.S. Cl. 347/29; 347/33

(57) ABSTRACT

A liquid discharger wherein, when a liquid discharge operation on a discharge object is started, a cap is opened in order to wipe a liquid discharge surface by bringing a cleaning member into contact with and moving the cleaning member along the liquid discharge surface, then liquid drops are preliminarily discharged to the cap from liquid discharge nozzles after the cleaning member has moved along the liquid discharge surface, and then, while the cap is withdrawn from the liquid discharge surface, prior to discharging liquid onto the discharge object, liquid drops are preliminarily discharged to a platen plate from the liquid discharge nozzles.

### CROSS-REFERENCE TO RELATED APPLICATIONS

This application is a divisional of the U.S. patent application Ser. No. 11/056,656, filed on Feb. 11, 2005, the entirety of which is incorporated herein by reference to the extent permitted by law. This application also claims the benefit of priority to P2004-037604 filed Feb. 16, 2004, which is also incorporated herein by reference to the extent permitted by law.

### BACKGROUND OF THE INVENTION

1. Field of the Invention

The present invention relates to a liquid discharger which discharges liquid drops onto discharge objects from liquid discharge nozzles of a liquid discharge head, and a method for controlling the same.

2. Description of the Related Art

An inkjet image forming device, such as an inkjet printer, which is an example of a liquid discharger, is in widespread use because, for example, it has a low operating cost, easily forms a colored print image, and is easily reduced in size. The inkjet printer records an image by discharging a very small amount of ink from very small ink discharge nozzles disposed at an ink discharge surface of what is called a serial print head. If the ink is not discharged from the ink discharge nozzles of the print head when a printing operation is not performed for a long period of time, any ink adhered to a location near any of the ink discharge nozzles at the ink discharge surface by previous printing may thicken and harden as a result of undergoing evaporation drying. Therefore, it becomes difficult to properly discharge the ink.

Therefore, conventionally, the print head has been cleaned by wiping the ink that has adhered to the ink discharge surface, thickened, and hardened as a result of pushing and sliding a blade, formed of, for example, a somewhat hard rubber, along the ink discharge surface of the print head. In relation to this, a technology for further increasing the wiping effect by rotating a plurality of blades mounted to a rotary shaft is disclosed in, for example, Japanese Unexamined Patent Application Publication No. 57-34969 (Patent Document 1).

A line print head is another type of print head in addition to the serial print head. The line print head having the same length as a recording sheet is disposed facing a transportation belt of the recording sheet and can perform printing by only transporting the recording sheet in a certain direction while the line print head is secured to holding means.

Therefore, it can achieve high-speed printing, and thus is primarily used for, for example, business purposes. A print head performs preliminary ink discharge when it is not printing in order to maintain its ink discharge performance. Some line print heads perform preliminary discharge to a recording sheet transportation belt.

The ink preliminarily discharged to the recording sheet transportation belt is cleaned by wiping it by the movement of the transportation belt in press-contact with, for example, a roller cleaner or a plate cleaner disposed at the downstream side of the transportation belt. Refer to, for example, Japanese Unexamined Patent Application Publication No. 2000-127362 (Patent Document 2).

In the technology disclosed in Patent Document 1, since the ink adhered to the ink discharge surface is wiped by pushing and sliding a blade, formed of, for example, a somewhat hard rubber, along the ink discharge surface of the print head, a large force is applied to the ink discharge surface by the blade. This may scratch the ink discharge surface.

Although, when the blade is used, its wiping effect must be depended upon, the ink cannot be completely removed from the ink discharge nozzle by only wiping. Even if a plurality of blades are used, similarly to the above case, the ink discharge surface may become scratched, and ink remains near the ink discharge nozzles.

In the technology disclosed in Patent Document 2, when, in the line print head, the wiping/cleaning means, such as a roller cleaner or a plate cleaner, is disposed at the most downstream side of the transportation belt, ink preliminarily discharged from an upstream ink discharge nozzle onto the transportation belt is, for example, dried and hardened during the time required from the preliminary discharge to the cleaning. Therefore, the preliminarily discharged ink may not be completely wiped.

For example, a fixing heater may be disposed in a recording sheet transportation area, in which case the heat from, for example, the heater may cause the preliminarily discharged ink to stick to the transportation belt.

There are ink types that quickly harden at a high temperature and low humidity, such as at a temperature of 35.degree. C. and a humidity of 30%. Therefore, in the technologies disclosed in Patent Documents 1 and 2, only cleaning the ink at a proper timing before starting a print operation or during the print operation on a recording sheet causes the ink to thicken and harden during the actual printing or near the completion of the actual printing on the recording sheet. Therefore, the ink may not be properly discharged or may stick to the transportation belt. In these cases, a reduction in print quality may occur during printing on one recording sheet.

### SUMMARY OF THE INVENTION

Accordingly, in order to overcome such problems, it is an object of the present invention to provide a liquid discharger which can prevent a liquid discharge surface of a liquid discharge head from becoming scratched, enhance the cleaning effect on liquid discharge nozzles, and has a stabilized and enhanced liquid discharging performance with respect to individual discharge objects, and a method for controlling the same.

To this end, according to a first aspect of the present invention, there is provided a liquid discharger comprising a liquid discharge head having a liquid discharge surface having liquid discharge nozzles, a cleaning member which wipes the liquid discharge surface while the cleaning member is in contact with and moves along the liquid discharge surface, a cap which accommodates the cleaning member therein and protects the liquid discharge surface of the liquid discharge head, cap opening-and-closing means which opens and closes the cap, the cap opening-and-closing means opening the cap to move the cleaning member and the cap perpendicularly to a row of the liquid discharge nozzles while the cleaning member is in contact with the liquid discharge surface of the liquid discharge head, driving controlling means which controls the driving of the cap opening-and-closing means, discharge controlling means which controls a discharge operation of the liquid drops from the liquid discharge nozzles disposed at the liquid discharge surface, and a platen plate which determines the relationship between the position of the discharge objects and the position of the liquid discharge head by supporting the discharge objects, the platen plate receiving the liquid drops discharged from the liquid discharge head. When the liquid discharge operation on one of the discharge objects is started, the driving controlling means performs the controlling to open the cap by driving the cap opening-and-closing means in order to wipe the liquid discharge surface by bringing the cleaning member into contact with and moving the cleaning member along the liquid discharge surface, then the discharge controlling means performs the controlling to preliminarily discharge the liquid drops to the cap from the liquid discharge nozzles after the cleaning member has moved along the liquid discharge surface, and then, while the cap is withdrawn from the liquid discharge surface, prior to discharging the liquid onto the discharge object, the discharge controlling means performs the controlling to preliminarily discharge the liquid drops to the platen plate from the liquid discharge nozzles.

By virtue of this structure, when a liquid discharge operation on a discharge object is started, the driving controlling means performs the controlling to open the cap by driving the cap opening-and-closing means in order to bring the cleaning member into contact with and move the cleaning member along the liquid discharge surface, so that the liquid discharge surface is wiped. After the cleaning member has moved along the liquid discharge surface, the discharge controlling means performs the controlling to preliminarily discharge liquid drops to the cap from the liquid discharge nozzles. Then, while the cap is withdrawn from the liquid discharge surface, prior to discharging the liquid onto the discharge object, the discharge controlling means performs the controlling to preliminarily discharge liquid drops to the platen plate from the liquid discharge nozzles. Therefore, the liquid discharge surface of the liquid discharge head is not scratched, the cleaning effect on the liquid discharge nozzles is enhanced, and the liquid discharging performance with respect to the individual discharge objects is stabilized and enhanced.

When the liquid discharge operation to the discharge object is started, the liquid drops are preliminarily discharged into the cap from the liquid discharge nozzles, and then liquid drops are preliminarily discharged to the platen plate from the liquid discharge nozzles immediately before discharging liquid to the discharge object. Therefore, even if the liquid is of a type that dries, thickens, and hardens quickly, it is possible to adjust the meniscus at the liquid discharge nozzles in order to stabilize and enhance the liquid discharge performance with respect to the individual discharge objects.

In a first form, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles. Therefore, the required cleaning steps are performed on the second discharge object and/or the subsequent discharge object or objects for a short period of time, that is not all of the cleaning steps are repeated on them. Consequently, even if the liquid is of a type that dries, thickens, and hardens quickly, it is possible to adjust the meniscus at the liquid discharge nozzles in order to stabilize and enhance the liquid discharge performance with respect to the individual discharge objects.

In a second form based on the first aspect or the first form, the liquid discharger further comprises a waste-liquid receiver which is disposed in the cap and which receives the liquid drops preliminarily discharged from the liquid discharge nozzles. Accordingly, since the waste-liquid receiver receives the liquid drops preliminarily discharged into the cap from the liquid discharge nozzles, the surrounding area is not stained. Consequently, the waste liquid can be held for a predetermined period of time.

In a third form based on the first aspect or the first form, the liquid discharger further comprises a liquid-waste receiver which is disposed at the platen plate and which receives the liquid drops preliminarily discharged from the liquid discharge nozzles. Accordingly, since the waste-liquid receiver receives the liquid drops preliminarily discharged to the platen plate from the liquid discharge nozzles, the surrounding area is not stained. Consequently, the waste liquid can be held for a predetermined period of time.

According to a second aspect of the present invention, there is provided a liquid discharger comprising a liquid discharge head having a liquid discharge surface having a row of liquid discharge nozzles for respective types of liquids, a cleaning member which wipes the liquid discharge surface while the cleaning member is in contact with and moves along the liquid discharge surface, a cap which accommodates the cleaning member therein and protects the liquid discharge surface of the liquid discharge head, cap opening-and-closing means which opens and closes the cap, the cap opening-and-closing means opening the cap to move the cleaning member and the cap perpendicularly to the row of the liquid discharge nozzles for the respective types of liquids while the cleaning member is in contact with the liquid discharge surface of the liquid discharge head, driving controlling means which controls the driving of the cap opening-and-closing means, discharge controlling means which controls a discharge operation of the liquid drops from the liquid discharge nozzles disposed at the liquid discharge surface, and a platen plate which determines the relationship between the position of the discharge objects and the position of the liquid discharge head by supporting the discharge objects, the platen plate receiving the liquid drops discharged from the liquid discharge head. When the liquid discharge operation on one of the discharge objects is started, the driving controlling means performs the controlling to open the cap by driving the cap opening-and-closing means in order to wipe the liquid discharge surface by bringing the cleaning member into contact with and moving the cleaning member along the liquid discharge surface, then the discharge controlling means performs the controlling to preliminarily discharge the liquid drops to the cap from the liquid discharge nozzles in the order in which the cleaning member passes the row of the liquid discharge nozzles for the respective types of liquids, and then, while the cap is withdrawn from the liquid discharge surface, prior to discharging the liquid onto the discharge object, the discharge controlling means performs the controlling to preliminarily discharge the liquid drops to the platen plate from the liquid discharge nozzles.

By virtue of this structure, when a liquid discharge operation on a discharge object is started, the driving controlling means performs the controlling to open the cap by driving the cap opening-and-closing means in order to bring the cleaning member into contact with and move the cleaning member along the liquid discharge surface, so that the liquid discharge surface is wiped. The discharge controlling means performs the controlling to preliminarily discharge liquid drops to the cap from the liquid discharge nozzles in the order in which the cleaning member has passed the row of the liquid discharge nozzles provided at the liquid discharge surface in correspondence with the plurality of types of liquids. Then, while the cap is withdrawn from the liquid discharge surface, prior to discharging the liquid onto the discharge object, the discharge controlling means performs the controlling to preliminarily discharge liquid drops to the platen plate from the liquid discharge nozzles.

Accordingly, the liquid discharger for discharging a plurality of types of liquids onto the discharge objects can prevent the liquid discharge surface of the liquid discharge head from becoming scratched, enhance the cleaning effect on the liquid discharge nozzles, and have a stabilized and enhanced liquid discharge performance with respect to individual discharge objects.

In a first form, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles. Therefore, the required cleaning steps are performed on the second discharge object and/or the subsequent discharge object or objects for a short period of time, that is not all of the cleaning steps are repeated on them. Consequently, even if the liquid is of a type that dries, thickens, and hardens quickly, it is possible to adjust the meniscus at the liquid discharge nozzles in order to stabilize and enhance the liquid discharge performance with respect to the individual discharge objects.

In a second form based on either the second aspect or the first form, the liquid discharger further comprises a waste-liquid receiver which is disposed in the cap and which receives the liquid drops preliminarily discharged from the liquid discharge nozzles. Accordingly, since the waste-liquid receiver receives the liquid drops preliminarily discharged into the cap from the liquid discharge nozzles, the surrounding area is not stained. Consequently, the waste liquid can be held for a predetermined period of time.

In a third form based on the second aspect or the first form, the liquid discharger further comprises a liquid-waste receiver which is disposed at the platen plate and which receives the liquid drops preliminarily discharged from the liquid discharge nozzles. Accordingly, since the waste-liquid receiver receives the liquid drops preliminarily discharged to the platen plate from the liquid discharge nozzles, the surrounding area is not stained. Consequently, the waste liquid can be held for a predetermined period of time.

According to a third aspect of the present invention, there is provided a method for controlling a liquid discharger. The method comprises the step of performing controlling such that, when a liquid discharge operation on one of the discharge objects is started, a cap is opened by driving cap opening-and-closing means in order to wipe a liquid discharge surface by bringing a cleaning member into contact with and moving the cleaning member along the liquid discharge surface, then the liquid drops are preliminarily discharged to the cap from the liquid discharge nozzles after the cleaning member has moved along the liquid discharge surface, and then, while the cap is withdrawn from the liquid discharge surface, prior to discharging the liquid onto the discharge object, the liquid drops are preliminarily discharged to the platen plate from the liquid discharge nozzles.

Therefore, the liquid discharge surface of the liquid discharge head is not scratched, the cleaning effect on the liquid discharge nozzles is enhanced, and the liquid discharging performance with respect to the individual discharge objects is stabilized and enhanced.

When the liquid discharge operation to the discharge object is started, the liquid drops are preliminarily discharged into the cap from the liquid discharge nozzles, and then liquid drops are preliminarily discharged to the platen plate from the liquid discharge nozzles immediately before discharging liquid to the discharge object. Therefore, even if the liquid is of a type that dries, thickens, and hardens quickly, it is possible to adjust the meniscus at the liquid discharge nozzles in order to stabilize and enhance the liquid discharging performance with respect to the individual discharge objects.

In a first form, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles. Therefore, only the required cleaning steps are performed on the second discharge object and/or the subsequent discharge object or objects for a short period of time, that is not all of the cleaning steps are repeated on them. Consequently, even if the liquid is of a type that dries, thickens, and hardens quickly, it is possible to adjust the meniscus at the liquid discharge nozzles in order to stabilize and enhance the liquid discharge performance with respect to the individual discharge objects.

In a second form based on either the third aspect or the first form, the liquid discharger further comprises a waste-liquid receiver which is disposed in the cap and which receives the liquid drops preliminarily discharged from the liquid discharge nozzles. Accordingly, since the waste-liquid receiver receives the liquid drops preliminarily discharged into the cap from the liquid discharge nozzles, the surrounding area is not stained. Consequently, the waste liquid can be held for a predetermined period of time.

In a third form based on the third aspect or the first form, the liquid discharger further comprises a liquid-waste receiver which is disposed at the platen plate and which receives the liquid drops preliminarily discharged from the liquid discharge nozzles. Accordingly, since the waste-liquid receiver receives the liquid drops preliminarily discharged to the platen plate from the liquid discharge nozzles, the surrounding area is not stained. Consequently, the waste liquid can be held for a predetermined period of time.

According to a fourth aspect of the present invention, there is provided a method for controlling a liquid discharger. The method comprises the step of performing controlling such that, when a liquid discharge operation on one of the discharge objects is started, a cap is opened by driving cap opening-and-closing means in order to wipe a liquid discharge surface by bringing a cleaning member into contact with and moving the cleaning member along the liquid discharge surface, then the liquid drops are preliminarily discharged to the cap from the liquid discharge nozzles in the order in which the cleaning member passes a row of the liquid discharge nozzles for respective types of liquids disposed at the liquid discharge surface, and then, while the cap is withdrawn from the liquid discharge surface, prior to discharging the liquid onto the discharge object, the liquid drops are preliminarily discharged to the platen plate from the liquid discharge nozzles.

Accordingly, the method for controlling a liquid discharger for discharging a plurality of types of liquids to the discharge objects can prevent the liquid discharge surface of the liquid discharge head from becoming scratched, enhance the cleaning effect on the liquid discharge nozzles, and provide a stabilized and enhanced liquid discharge performance with respect to individual discharge objects.

When the liquid discharge operation to a discharge objects is started, liquid drops are preliminarily discharged into the cap from the liquid discharge nozzles in the order in which the cleaning member has passed the row of liquid discharge nozzles provided at the liquid discharge surface in correspondence with the plurality of types of liquids, and then liquid drops are preliminarily discharged to the platen plate from the liquid discharge nozzles immediately before discharging liquid to the discharge objects. Therefore, even if the liquid is of a type that dries, thickens, and hardens quickly, it is possible to adjust the meniscus at the liquid discharge nozzles in order to stabilize and enhance the liquid discharge performance with respect to the individual discharge objects.

In a first form, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles. Therefore, the required cleaning steps are performed on the second discharge object and/or the subsequent discharge object or objects for a short period of time, that is not all of the cleaning steps are repeated on them. Consequently, even if the liquid is of a type that dries, thickens, and hardens quickly, it is possible to adjust the meniscus at the liquid discharge nozzles in order to stabilize and enhance the liquid discharge performance with respect to the individual discharge objects.

In a second form based on either the fourth aspect or the first form, the liquid discharger further comprises a waste-liquid receiver which is disposed in the cap and which receives the liquid drops preliminarily discharged from the liquid discharge nozzles. Accordingly, since the waste-liquid receiver receives the liquid drops preliminarily discharged into the cap from the liquid discharge nozzles, the surrounding area is not stained. Consequently, the waste liquid can be held for a predetermined period of time.

In a third form based on the fourth aspect or the first form, the liquid discharger further comprises a liquid-waste receiver which is disposed at the platen plate and which receives the liquid drops preliminarily discharged from the liquid discharge nozzles. Accordingly, since the waste-liquid receiver receives the liquid drops preliminarily discharged to the platen plate from the liquid discharge nozzles, the surrounding area is not stained. Consequently, the waste liquid can be held for a predetermined period of time.

### BRIEF DESCRIPTION OF THE DRAWINGS

FIG. 1 is schematic perspective view of an inkjet printer serving as a liquid discharger in accordance with an embodiment of the present invention;

FIG. 2 is a perspective view showing a state in which a head cartridge is accommodated in an accommodation section after opening a top cover of the inkjet printer;

FIG. 3 is a partial sectional side view of the structure of the head cartridge;

FIG. 4 shows the internal structure of a printer body shown in FIG. 2 after removing an outer cover;

FIG. 5 shows a cap opening-and-closing mechanism shown in FIG. 4;

FIG. 6 is a sectional view of the internal structure of the inkjet printer shown in FIG. 1 before the head cartridge at rest starts to operate;

FIG. 7 shows a state in which a head cap of the head cartridge is withdrawn to its withdrawal position and print operation can be carried out;

FIG. 8 shows a state in which the printer body is open when maintaining the inkjet printer;

FIGS. 9A and 9C show a platen plate disposed below the head cartridge of the inkjet printer in accordance with the embodiment;

FIG. 10 is a sectional view of an ink-absorbing material and ribs disposed at the platen plate;

FIG. 11 is a block diagram for illustrating the operation and the structure of a controller for controlling the inkjet printer;

FIG. 12 is a flowchart of the method for controlling the inkjet printer serving as a liquid discharger in accordance with the present invention; and

FIGS. 13A to 13F illustrate the cleaning steps in the inkjet printer.

### DESCRIPTION OF THE PREFERRED EMBODIMENTS

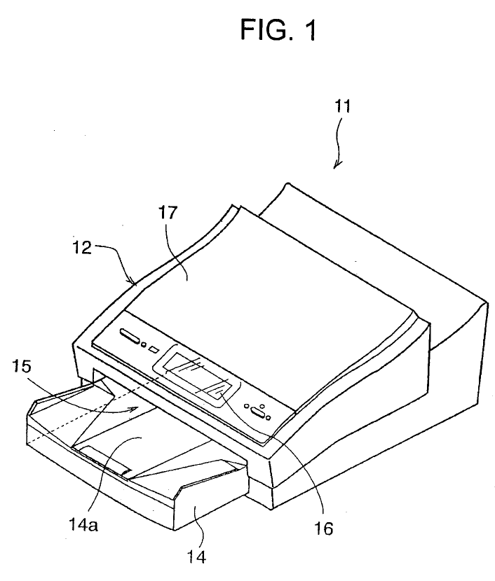

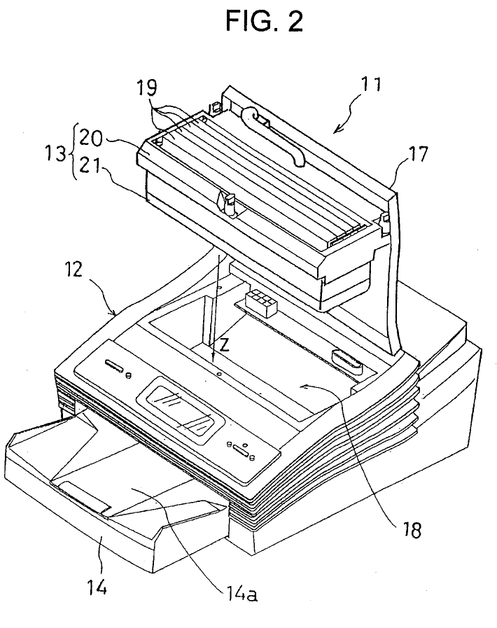

An embodiment of the present invention will hereunder be described in detail with reference to the attached drawings. FIG. 1 shows an inkjet printer, which is an example of a liquid discharger, in accordance with an embodiment of the present invention. An inkjet printer 11 forms an image by discharging ink drops (a predetermined liquid) onto predetermined locations of a recording sheet (discharge object), and comprises a printer body 12, a head cartridge 13 (see FIG. 2), and a recording-sheet tray 14.

A transportation mechanism for transporting recording sheets accommodated in the recording-sheet tray 14 and an electrical circuit for performing suitable printing on the recording sheets are accommodated in the printer body 12. The recording-sheet tray 14 is removably mounted to a tray insertion slot 15 formed in the lower front portion of the printer body 12. The tray insertion slot 15 is also a recording sheet discharge slot. A recording sheet on which printing has been performed in the printer body 12 is discharged onto a sheet-discharge receiver 14a at the upper surface of the recording-sheet tray 14. A display panel 16 for displaying the state of the operation of the entire inkjet printer 11 is disposed on the upper front portion of the printer body 12.

A top cover 17 is mounted to the top surface of the printer body 12 so as to be openable and closable. As shown in FIG. 2, when the top cover 17 is opened, an accommodation section 18 for accommodating the head cartridge 13 can be seen being disposed in the upper surface of the printer body 12. The accommodation section 18 accommodates the head cartridge 13 in the direction of arrow Z, and removably holds the head cartridge 13. The head cartridge 13 comprises a print head 20 and a head cap 21. The print head 20 has ink tanks 19 provided in correspondence with a plurality of types of liquids, that is, ink types of four colors, yellow Y, magenta M, cyan C, and black K. The head cap 21 is mounted to the lower surface of the print head 20. The print head 20 is called a full-line print head. A row of ink discharge nozzles are disposed at the ink discharge surface at the lower surface of the print head 20 in correspondence with the overall width of a recording sheet (such as an A4 size sheet). Ink is discharged onto the recording sheet while the print head 20 is secured in the accommodation section 18 of the printer body 12 in order to form an image of a required width.

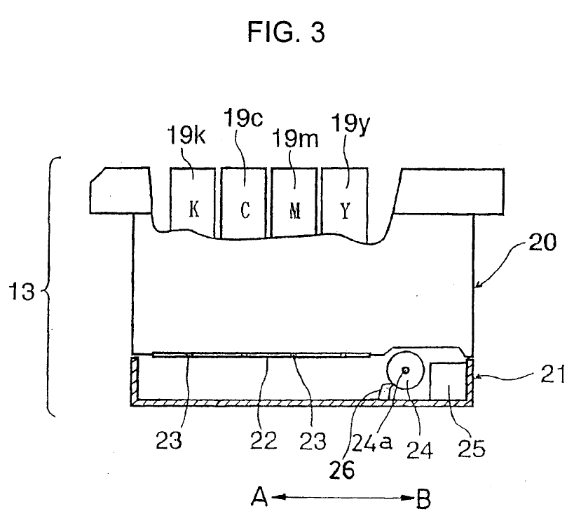

FIG. 3 is a partial sectional side view of the structure of the head cartridge 13. The ink tanks 19 are liquid containers storing ink therein and correspond to four tanks 19y, 19m, 19c, and 19k which correspond to the ink types of the four colors Y, M, C, and K and which are removably set. The print head 20 is a liquid discharge head which discharges the ink supplied thereto from the ink tanks 19y, 19m, 19c, and 19k. The row of ink discharge nozzles (liquid discharge nozzles) 23 corresponding to the four colors, Y, M, C, and K, is formed in an ink discharge surface (liquid discharge surface) 22 at the lower surface of the print head 20.

The head cap 21 is mounted under the print head 20 so as to move relative to and to be removable from the print head 20, protects the ink discharge surface 22 of the print head 20, has, for example, an elongated box shape having upstanding portions at its four peripheral sides. The head cap 21 has a cleaning roller (cleaning member) 24, a scraper 26, and a waste-liquid receiver 25 disposed therein. The cleaning roller wipes any thickened and adhered ink residue while moving along the ink discharge surface 22. The scraper 26 scrapes off any ink residue adhered to the outer peripheral surface of the cleaning roller 24. The waste-liquid receiver 25 receives any preliminarily discharged ink from the ink discharge nozzles 23. The head cap 21 is moved in the directions of arrows A and B, which are perpendicular to a longitudinal direction of the ink discharge surface 22 of the print head 20, by moving means, such as a motor. The head cap 21 is removed from the print head 20 when it has moved in the direction of arrow A, and is mounted again to the print head 20 when it has returned in the direction of arrow B. The head cap 21 is formed of, for example, hard resin.

The cleaning roller 24 wipes the ink discharge surface 22 while contacting and moving along the ink discharge surface 22 of the print head 20, is formed of, for example, sponge having resiliency and moisture absorption characteristics, is cylindrical, and is mounted to one side in the head cap 21 in the longitudinal direction of the head cap 21. Therefore, the cleaning roller 24 is parallel with the longitudinal direction of the ink discharge surface 22 of the print head 20. The cleaning roller 24 cleans the ink discharge surface 22 of the print head 20 by moving along with the head cap 21.

The waste-liquid receiver 25 disposed in the head cap 21 receives any preliminarily discharged ink drops from the ink discharge nozzles 23 of the print head 20, is formed of, for example, sponge having moisture absorption characteristics. A portion of or the entire bottom surface of the head cap 21 receives preliminarily discharged ink drops. This makes it possible to prevent any ink preliminarily discharged from the ink discharge nozzles 23 from splashing and to absorb the ink so that it does not accumulate at the bottom surface of the head cap 21. Therefore, it is possible to prevent the preliminarily discharged ink from re-adhering to the ink discharge surface 22 caused by the splashing of the preliminarily discharged ink from the waste-liquid receiver 25. The waste-liquid receiver 25 is used for a suitable period of time, and an ink absorbing material that has absorbed the preliminarily discharged ink is removed from the waste-liquid receiver 25 and discarded. Thereafter, by providing a new absorbing material, it is possible to easily clean any preliminarily discharged ink.

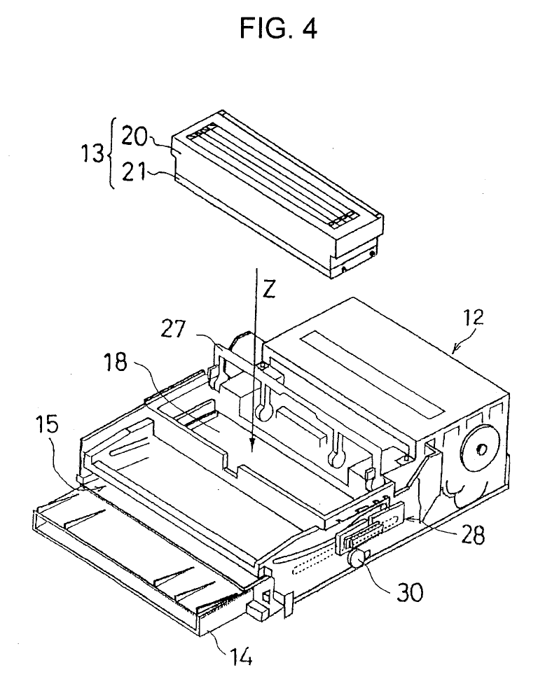

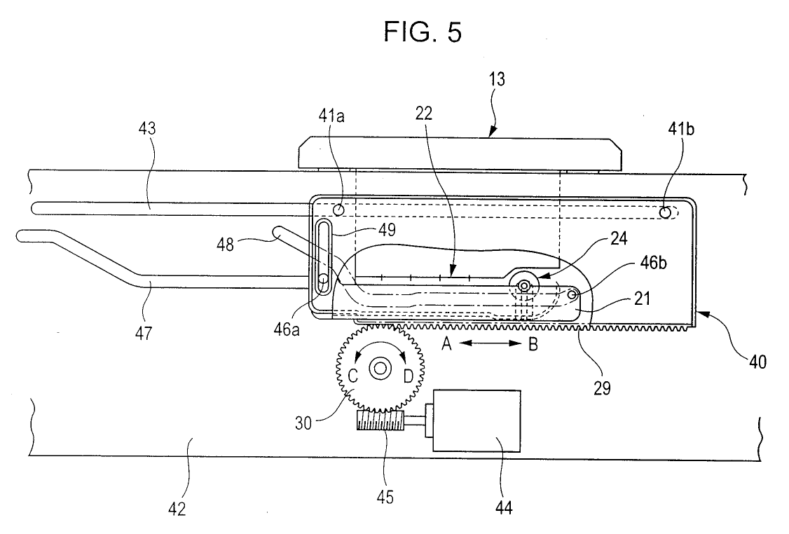

Next, the structure for moving the head cap 21 will be described with reference to FIGS. 4 and 5. FIG. 4 shows the internal structure of the printer body 12 shown in FIG. 2 after removal of an outer cover, and FIG. 5 shows a head cap opening-and-closing mechanism. In FIG. 4, after moving the head cartridge 13 downward in the direction of arrow Z towards the printer body 12 and accommodating it in the accommodation section 18, a head mounting-and-dismounting mechanism 27 is tilted forward by approximately 90 degrees in order to secure the head cartridge 13 to the printer body 12. Here, the head cap 21 shown in FIG. 4 engages a head cap opening-and-closing mechanism 28.

FIG. 5 is a side view showing in detail the head cap opening-and-closing mechanism 28 shown in FIG. 4. First, the head cap 21 to which the cleaning roller 24 shown in FIG. 3 is mounted is linked to and supported by a movement rack plate 40 having a linear rack 29 disposed at a lower side as shown in FIG. 5. The movement rack plate 40 moves the head cap 21 in the directions of arrows A and B, and is supported when two guide pins 41a and 41b engage a linear movement guide groove 43 and the rack 29 engages a pinion 30 rotated by a worm gear 45 on a rotary shaft of a movement motor 44. The guide pins 41a and 41b are disposed, one at each end of the upper portion of an inside surface of the movement rack plate 40. The movement guide groove 43 is formed in one of the outer plates 42 of the printer body 12. The movement motor 44 is mounted to the same outer plate 42.

A front cap guide pin 46a and a back cap guide pin 46b are disposed so as to protrude from one of the outer surfaces of the head cap 21 and towards the movement rack plate 40. Two cap guide grooves 47 and 48 which are curved into predetermined shapes for defining a movement path of the head cap 21 are formed in an intermediate portion of one of the outer plates 42 of the printer body 12. The front cap guide pin 46a and the back cap guide pin 46b at the head cap 21 engage the cap guide grooves 47 and 48 of the outer plate 42 of the printer body 12, respectively, and only the front cap guide pin 46a engages a guide groove 49 which is longer than is wide and is formed in the front end of the movement rack plate 40.

By this mechanism, driving the movement motor 44 rotates the pinion 30 in either of the directions of arrows C and D via the worm gear 45. The rack 29 engaging the pinion 30 causes the movement rack plate 40 to move in either of the directions of arrows A and B. Here, since the cap guide 46a at the front portion of the head cap 21 engages the guide groove 49 at the front end of the movement rack plate 40, the head cap 21 moves in either of the directions of arrows A and B along with the movement rack plate 40. Here, the path of movement of the head cap 21 is determined by the shapes of the cap guide grooves 47 and 48 with which the two cap guide pins 46a and 46b engage.

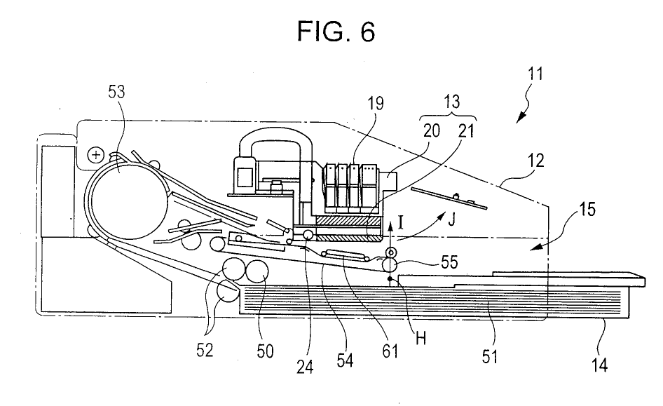

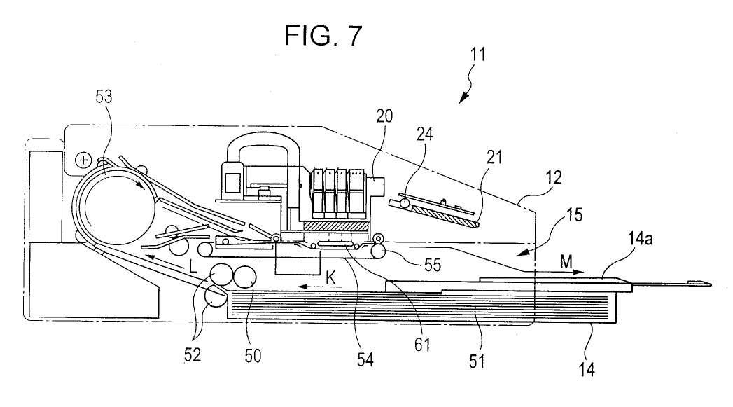

FIG. 6 is a sectional view of a specific example of the internal structure of the inkjet printer 11, and shows the head cartridge 13 at rest before it starts operating. FIG. 7 shows a state in which printing can be carried out as a result of withdrawal of the head cap 21 which had been hermetically sealing and protecting the ink discharge surface 22 of the print head 20 to its withdrawal position. As shown in FIG. 6, in the inkjet printer 11, sheet-feeding means 50 comprising a roller is disposed at an upper portion of an insertion-direction end of the recording-sheet tray 14 mounted to the tray insertion slot 15 disposed at the lower front portion of the printer body 12 in order to make it possible to supply recording sheets 51 in the recording-sheet tray 14 any time.

Separating means 52 comprising two opposing rollers is disposed in the direction of supply of the recording sheets 51 in order to make it possible to feed the accommodated stacked recording sheets 51 by separating them one at a time. A reverse roller 53 for reversing the direction of transportation of the recording sheets 51 is disposed forwardly of the recording sheets 51 separated by the separating means 52 in the direction of transportation thereof and at the upper portion of the printer body 12.

Belt conveying means 54 and a platen plate 61 (described later) are disposed forwardly of the recording sheets 51 reversed by the reverse roller 53 in the direction of transportation thereof. As shown in FIG. 6, when the printing is not performed, an end 55 of the belt conveying means 54 is lowered in the direction of arrow H, so that a large gap is formed between the end 55 and the lower surface of the print head 20. During the print operation shown in FIG. 7, the end 55 of the belt conveying means 54 is raised in the direction of arrow I and is set horizontally, so that a recording-sheet path having a predetermined small gap is formed between the end 55 and the lower surface of the print head 20.

As shown in FIG. 6, when the printing is not performed, the lower surface of the print head 20 is closed with the head cap 21 in order to prevent clogging of the ink discharge nozzles 23 by dried ink. The cleaning roller 24 in the head cap 21 cleans the ink discharge nozzles 23 when the head cap 21 withdraws to its predetermined withdrawal position (see FIG. 7) prior to starting the print operation.

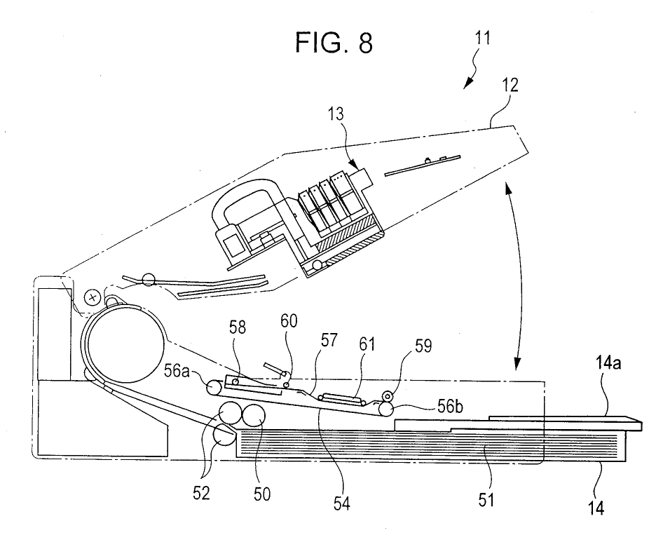

As shown in FIG. 8, the inkjet printer 11 having this structure comprises a mechanism for opening the printer body 12 when carrying out maintenance, so that it is possible to, for example, prevent sheet jamming. The belt conveying means 54 has a conveying belt 57 wound between two main pulleys 56a and 56b, with a tension roller 58 for adjusting the tension of the conveying belt 57 being disposed at the conveying belt 57. A guide plate and an opposing pinch roller 60 are disposed at a recording-sheet-51 supply side of the print head 20, and a spur roller 59 is disposed at the discharge side of the recording sheets 51. Accordingly, a predetermined transportation path is formed.

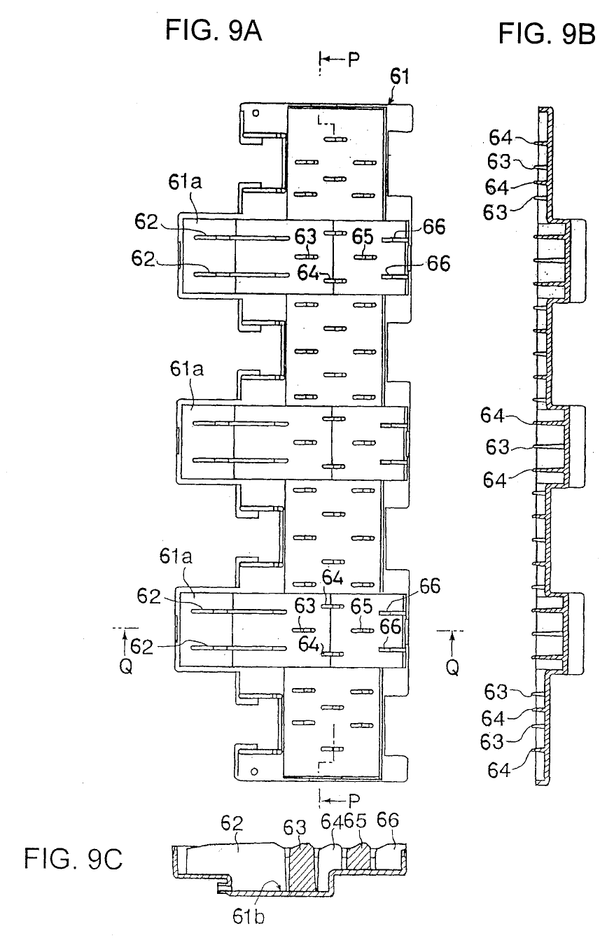

The platen plate 61 is disposed above the belt conveying means 54. The platen plate 61 supports the recording sheets 51 in order to define their position with respect to the print head 20, and receives ink drops discharged from the print head 20. As shown in FIG. 9A, the platen plate 61 is formed with an elongated box shape having upstanding portions at its peripheries over a width in correspondence with the dimension of the entire width of the ink discharge surface 22 of the print head 20. The entire platen plate 61 is formed of ABS resin. In the platen plate 61, projections 61a are disposed upstream in the direction of transportation of the recording sheets 51 in order to stably transport the recording sheets 51 and sufficiently store the discharged ink drops. As shown in FIG. 9C, first ribs 62 to fifth ribs 66 disposed in a standing manner from a bottom surface 61b and extending in the direction of transportation of the recording sheets 51 are disposed at a predetermined interval in the widthwise direction of the platen plate 61 shown in FIG. 9A.

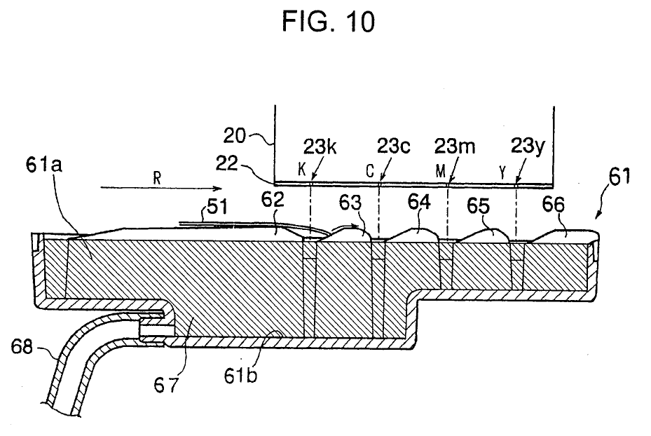

As shown in FIG. 10, the platen plate 61 is disposed so as to oppose the ink discharge surface 22 at the lower surface of the print head 20. The platen plate 61 serves as a member for supporting the back surface of a recording sheet to which ink drops have been discharged from the ink discharge nozzles 23k, 23k, 23m, and 23y disposed at the ink discharge surface 22 and as an ink reservoir for storing the excess ink drops discharged beyond an end of the recording sheet 51.

As shown in FIG. 10, the first ribs 62 to the fifth ribs 66 are disposed from the upstream side to the downstream side of the recording sheets 51 in the direction of transportation thereof, and the top portions of the first rib 62 to the fifth rib 66 have substantially the same height and are formed so as to determine the distance between a recording sheet 51 and the ink discharge surface 22 by supporting the back surface of the recording sheet 51 at an area outside an area to which the ink drops discharged from the ink discharge nozzles 23 at the ink discharge surface 22 are adhered. In the area to which the ink drops discharged from the ink discharge nozzles 23 are adhered, the ribs are not formed.

The waste-liquid receiver is formed by the recess in the bottom surface 61b of the platen plate 61 shown in FIG. 10. In the waste-liquid receiver, an ink-absorbing material 67 is provided in the area to which the ink drops have been discharged from the ink discharge nozzles 23 at the ink discharge surface 22. The ink-absorbing material 67 is a liquid absorbing material for absorbing the ink drops discharged from the ink discharge nozzle 23, and is, for example, sponge. For example, when performing margin-less printing, the ink-absorbing material 67 absorbs any ink drops discharged beyond a peripheral edge of a recording sheet 51. This makes it possible to reduce splashing of the ink drops vigorously discharged from the ink discharge nozzles 23, thereby preventing staining of and damage to the back surface of the recording sheet 51. The ink-absorbing material 67 makes it possible to prevent ink from spilling caused by vibration even if a certain amount of ink is stored.

A waste ink tube 68 is mounted to the bottom surface 61b of the platen plate 61. Ink preliminarily discharged from the ink discharge nozzles 23 and absorbed by the ink-absorbing material 67 is such as to flow out of the platen plate 61 from the waste ink tube 68. Therefore, even if a large amount of ink is discharged, it is prevented from overflowing from the platen plate 61, thereby preventing the ribs 62 to 66 from becoming stained and damaged. The ink discharged from the waste ink tube 68 accumulates in a waste ink tank (not shown). The platen plate 61 is removable for increasing maintainability, and thus can be easily cleaned by removing it when it is stained with ink.

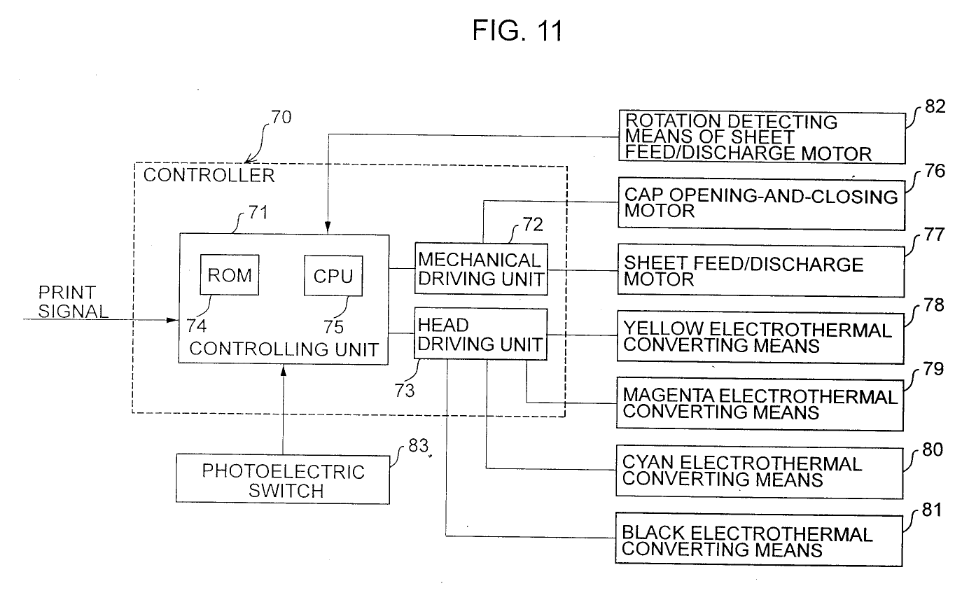

FIG. 11 is a block diagram illustrating the operation and structure of a controller 70 for controlling the inkjet printer 11 having the above-described structure. The controller 70 controls the driving of the moving means for moving the head cap 21 accommodating the cleaning roller 24 and the discharge operation of ink from the ink discharge nozzles 23 of the print head 20. The controller 70 comprises a controlling unit 71, a mechanical driving unit 72, and a head driving unit 73.

The controlling unit 71 is driving controlling means for controlling the driving of a cap opening-and-closing motor 76 (described later) for opening and closing the head cap 21 and discharge controlling means for controlling the discharge operation of ink from the ink discharge nozzles 23. The controlling unit 71 comprises ROM 74 for storing various pieces of information and control programs therein and a CPU 75 for sending out various control commands on the basis of the control programs read out from ROM 74. Accordingly, the controlling unit 71 controls the mechanical driving unit 72 and the head driving unit 73 (both of which are described later).

The mechanical driving unit 72 drives the cap opening-and-closing motor 76 for opening and closing the head cap 21 and a sheet feed/discharge motor 77 for supplying and discharging the recording sheets 51. The cap opening-and-closing motor 76 is moving means for moving the outer peripheral surface of the cleaning roller 24 and the ink discharge surface 22 of the print head 20 relative to each other while they are in contact with each other. Rotation detecting means 82 comprising an encoder is mounted to the rotary shaft of the sheet feed/discharge motor 77. The encoder detects the rotational angle of the rotary shaft. The rotation detecting means 82 of the sheet feed/discharge motor detects the state of feeding of the recording sheets 51 to the print head 20 and sends out a detection signal to the controlling unit 71.

The head driving unit 73 drives a device for discharging ink from the ink discharge nozzles 23 corresponding to the respective colors and disposed at the ink discharge surface 22 of the print head 20, and sends out drive signals to yellow electrothermal converting means 78, magenta electrothermal converting means 79, cyan electrothermal converting means 80, and black electrothermal converting means 81, respectively. The converting means 78 to 81 comprise, for example, heating resistors.

The controller 70 having the above-described structure performs controlling so that a print signal indicating an image formation operation is input to the controlling unit 71 from an external device, a detection signal is input to the controlling unit 71 from a photoelectric switch 83 which detects the locations of the print head 20 (shown in FIG. 3) corresponding to the locations of the ink discharge surface 22 for the corresponding colors, drive signals are sent to the mechanical driving unit 72 and the head driving unit 73, and yellow Y ink, magenta M ink, cyan C ink, and black B ink are preliminarily discharged into the head cap 21 in that order, that is, ink is discharged from the row of the ink discharge nozzles 23 of the corresponding colors at the ink discharge surface 22 in the order in which the cleaning roller 24 passes them.

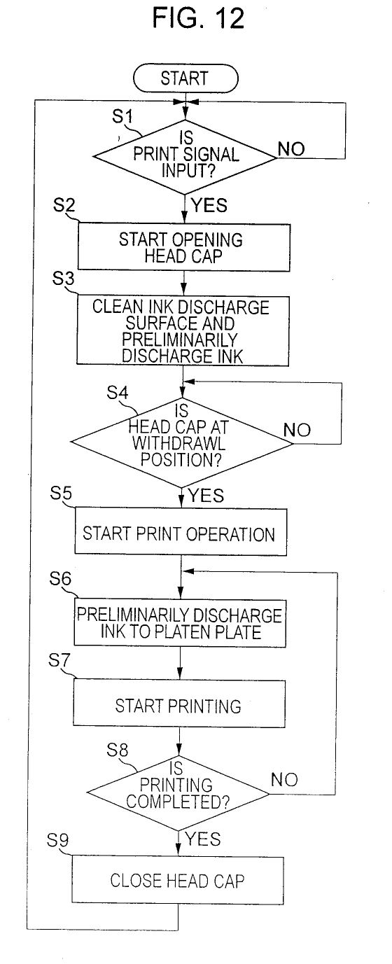

FIG. 12 is a flowchart showing the method for controlling the inkjet printer 11 having the above-described structure, and primarily shows the controlling of a print operation. The controlling is executed by a command from the CPU 75 on the basis of the control programs stored in ROM 74 in the controlling unit 71 shown in FIG. 11.

When a print signal indicating the start of the image formation operation is input to the controlling unit 71 (shown in FIG. 11) in Step S1 (shown in FIG. 12), the controlling unit 71 starts opening the head cap 21 by driving the cap opening-and-closing motor 76 as a result of sending out a cap opening trigger signal to the mechanical driving unit 72 in Step S2. Next, in Step S3, the cleaning roller 24 wipes and cleans the ink discharge surface 22 in accordance with the opening of the head cap 21, and the controlling unit 71 sends out a preliminary discharge signal to the head driving unit 73 in order to preliminarily discharge ink to the head cap 21.

Next, in Step S4, a confirmation is made as to whether or not the head cap 21 has reached its withdrawal position. Then, in Step S5, a print operation is started. In Step S6, ink is preliminarily discharged to the platen plate 61 immediately before discharging ink for actual printing onto a recording sheet 51. Accordingly, by preliminarily discharging ink to the platen plate 61 from the ink discharge nozzles 23 immediately before printing, even if the ink is of a type that quickly dries, thickens, and hardens, the meniscus at the ink discharge nozzles 23 is adjusted in order to stabilize and enhance the ink discharging performance. In this state, the printing for forming an image on the recording sheet 51 is started on the basis of the print signal in Step S7.

When, in Step S8, a determination is made as to whether or not the print operation is completed, and the print operation for printing one recording sheet 51 is completed, the process proceeds to Step S9. Therefore, the controlling unit 71 sends out a cap closing trigger signal to the mechanical driving unit 72 in order to drive the cap opening-and-closing motor 76, thereby closing the head cap 21 in Step S9. Thereafter, the aforementioned steps are repeated in accordance with the input of a print signal.

In contrast, when printing is to be continued on a second and subsequent recording sheets 51, the process returns to Step S6 from Step S8 in order to preliminarily discharge ink to the platen plate 61 while the head cap 21 is at its withdrawal position prior to ink discharge for actual printing on the next recording sheet 51. Thereafter, in this state, printing is started for forming an image onto the next recording sheet 51 on the basis of the print signal in Step S7.

After completing the printing on the predetermined number of recording sheets 51 by repeating Steps S6 to S8 for the predetermined number of recording sheets 51, the process proceeds to Step S9 from Step S8. Therefore, the controlling unit 71 sends out a cap closing trigger signal to the mechanical driving unit 72 in order to drive the cap opening-and-closing motor 76, thereby closing the head cap 21 in Step S9.

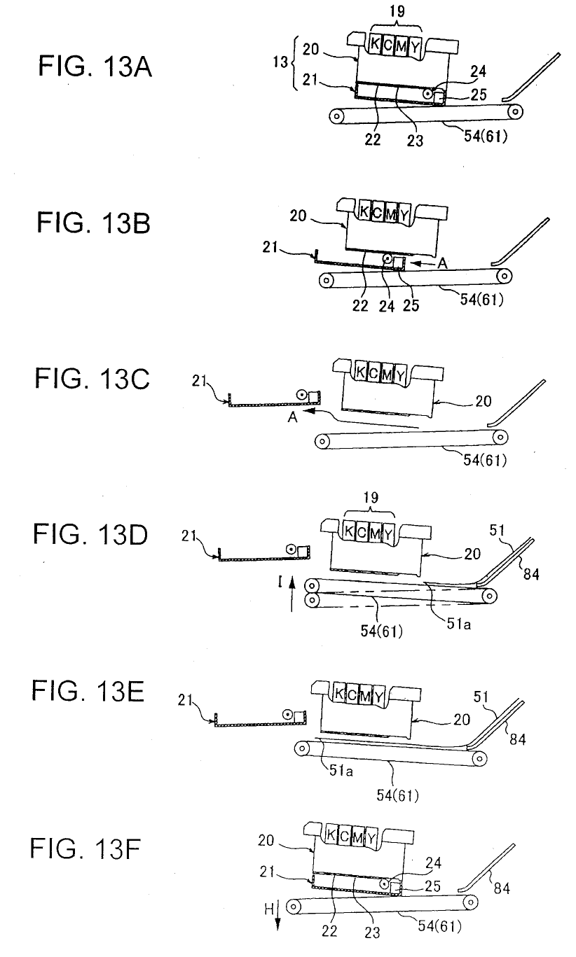

Next, the cleaning steps in the inkjet printer 11 having the above-described structure will be described with reference to FIGS. 13A to 13F. FIG. 13A shows an initial state in which the head cap 21 is at its closed position with respect to the ink discharge surface 22 of the print head 20, and protects the ink discharge nozzles 23 of the four respective colors Y, M, C, and K at the ink discharge surface 22.

From this state, when a cap opening trigger signal is input to the printer body 12, for example, when a command is given by a user, at the start of printing, or at the time of printer start-up, the movement motor 44 shown in FIG. 5 is rotationally driven, causing the head cap 21 to starting moving in the direction of arrow A as shown in FIG. 13B. Here, the movement of the head cap 21 causes the cleaning roller 24 to successively undergo coupled rotation and move while rubbing the ink discharge surface 22 which is pushed by and is in contact with the cleaning roller 24. While the cleaning roller 24 rotates and moves, it wipes any ink residue which has thickened and hardened in the ink discharge nozzles 23 corresponding to the four colors Y, M, C, and K.

After wiping the ink residue by the cleaning roller 24, when, for example, an optical or a mechanical sensor (not shown) detects that the waste-liquid receiver 25 (see FIG. 3) in the head cap 21 has reached a location directly below a particular one of the ink discharge nozzles 23 of the respective colors, ink is preliminarily and successively discharged to the waste-liquid receiver 25 in order to prevent clogging of the ink discharge nozzles 23. FIG. 13B shows a state in which ink is preliminarily discharged to the waste-liquid receiver 25 that has reached the location directly below the yellow ink discharge nozzle 23 after wiping the ink residue in the yellow ink discharge nozzle 23 with the cleaning roller 24. Thereafter, after wiping any ink residue in the M, C, and K ink discharge nozzles 23 with the cleaning roller 24, ink is successively preliminarily discharged to the waste-liquid receiver 25 that has successively reached the locations directly below the ink discharge nozzles 23 for these colors.

Accordingly, when the wiping with the cleaning roller 24 and the preliminary ink discharge have been completed for all four of the Y, M, C, and K ink discharge nozzles 23, as shown in FIG. 13C, the head cap 21 is fully moved in the direction of arrow A, is moved in the direction of arrow J in FIG. 6, and is fixed at its withdrawal position.

In this state, as shown in FIG. 13D, the belt conveying means 54 and the platen plate 61 (shown in FIG. 6) move upward in the direction of arrow I so as to allow the transportation of a recording sheet 51. This allows the printer body 12 and the head cartridge 13 to perform printing. At this time, the recording sheet 51 is supplied by the sheet guide 84, and an end 51a of the recording sheet 51 moves to a location adjacent to the print head 20 and waits there. The rotation detecting means 82 of the sheet feed/discharge motor (shown in FIG. 11) detects that the end 51a of the recording sheet 51 is in the waiting state and that it is in a state immediately before printing in order to preliminarily discharge ink to the platen plate 61 from the ink discharge nozzles 23. This makes it possible to prevent the ink discharge surface 22 of the print head 20 from becoming scratched and to increase the cleaning effect near the ink discharge nozzles 23. Even if the ink is of a type that dries, thickens, and hardens quickly, it is possible to adjust the meniscus at the liquid discharge nozzles 23 in order to stabilize and enhance the ink discharging performance with respect to the individual recording sheets 51.

Thereafter, as shown in FIG. 13E, the recording sheet 51 which is supported by the ribs 62 to 66 of the platen plate 61 is transported. With the end 51a being at a location below the ink discharge surface 22 of the print head 20, ink is discharged from the ink discharge nozzles 23, so that actual printing is performed on the recording sheet 51. Here, printing on the second recording sheet 51 and the subsequent recording sheets 51 are subjected to printing only by repeating the steps shown in FIGS. 13D and 13E, so that not all of the steps are repeated. This allows regular printing to be carried out on each recording sheet 51 after preliminarily discharging ink to the platen plate 61 immediately before the printing.

When the printing on a predetermined number of pages is completed, a cap closing trigger signal is input to the printer body 12, so that, as shown in FIG. 13F, the belt conveying means 54 and the platen plate 61 move downward in the direction of arrow H. The movement motor 44 shown in FIG. 5 rotates in the opposite direction, causing the head cap 21 to return to its initial state shown in FIG. 13A by moving from its withdrawal position through the same path that it took to reach its withdrawal position. In the return path, the cleaning roller 24 does not wipe the ink discharge nozzles 23 and ink is not preliminarily discharged. This is to increase the life of the cleaning roller 24, that is, to increase the time required until replacement.

When all of the printing on the recording sheets 51 is completed, as shown in FIG. 7, the recording sheets 51 are transported in the direction of arrow M from below the print head 20 and are discharged to the discharge-sheet receiver 14a at the top surface of the recording-sheet tray 14 from the tray insertion slot also serving as a discharge-sheet slot.

Although, in the description above, the cleaning roller 24 is cylindrical and is formed of, for example, sponge having resiliency and moisture absorption characteristics, the present invention is not limited thereto. The cleaning roller 24 may be a flat blade formed of, for example, sponge having resiliency and moisture absorption characteristics, a flat blade formed of a resilient material such as rubber, or a combination of any two of the cleaning roller, the flat blade formed of, for example, sponge, and the flat blade formed of, for example rubber.

Although, in the description above, the inkjet printer comprising a full-line print head is taken as an example, the present invention is not limited thereto. The present invention may be applied to any device as along as it discharges drops of a liquid contained in a liquid chamber of a liquid discharge head from a liquid discharge nozzle. For example, the present invention may be applied to an image forming device, such as a copying machine or a facsimile machine, whose recording method is an inkjet method. In addition, the present invention may be applied to a piezoelectric inkjet printer or an inkjet printer comprising a serial print head.

The liquid discharged from the liquid discharge nozzles is not limited to ink. Therefore, the present invention may be applied to liquid dischargers for discharging other types of liquids as long as the liquid dischargers form dots or a row of dots of a predetermined liquid discharged by driving a liquid discharge head. For example, the present invention may be applied to a liquid discharger for discharging a solution containing DNA to a pallet in, for example, DNA examination or a liquid discharger for discharging a liquid containing conductive particles in order to form a wiring pattern on a printed wiring board.

What is claimed is:

1. A liquid discharger for discharging liquid drops onto discharge objects from liquid discharge nozzles, the liquid discharger comprising:
a liquid discharge head having a liquid discharge surface having the liquid discharge nozzles;
a cleaning member which wipes the liquid discharge surface while the cleaning member is in contact with and moves along the liquid discharge surface;
a cap which accommodates the cleaning member therein and protects the liquid discharge surface of the liquid discharge head;
a cap opening-and-closing unit which opens and closes the cap, the cap opening-and-closing unit opening the cap to move the cleaning member and the cap perpendicularly to a row of the liquid discharge nozzles while the cleaning member is in contact with the liquid discharge surface of the liquid discharge head;
a driving controlling unit which controls the driving of the cap opening-and-closing unit;
a discharge controlling unit which controls a discharge operation of the liquid drops from the liquid discharge nozzles disposed at the liquid discharge surface; and
a platen plate which determines the relationship between the position of the discharge objects and the position of the liquid discharge head by supporting the discharge objects, the platen plate receiving the liquid drops discharged from the liquid discharge head,
wherein,
when the liquid discharge operation on one of the discharge objects is started, the driving controlling unit performs the controlling to open the cap by driving the cap opening-and-closing unit in order to wipe the liquid discharge surface by bringing the cleaning member into contact with and moving the cleaning member along the liquid discharge surface, then the discharge controlling unit performs the controlling to preliminarily discharge the liquid drops to the cap from the liquid discharge nozzles after the cleaning member has moved along the liquid discharge surface, and then, while the cap is withdrawn from the liquid discharge surface, prior to discharging the liquid onto the discharge object, the discharge controlling unit performs the controlling to preliminarily discharge the liquid drops to the platen plate from the liquid discharge nozzles.

2. The liquid discharger according to claim 1, wherein, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles as a result of the controlling by the discharge controlling unit.

3. The liquid discharger according to claim 1 or claim 2, further comprising a liquid-waste receiver which is disposed at the platen plate and which receives the liquid drops preliminarily discharged from the liquid discharge nozzles.

4. A liquid discharger for discharging liquid drops onto discharge objects from liquid discharge nozzles, the liquid discharger comprising:
a liquid discharge head having a liquid discharge surface having a row of the liquid discharge nozzles for respective types of liquids;
a cleaning member which wipes the liquid discharge surface while the cleaning member is in contact with and moves along the liquid discharge surface;
a cap which accommodates the cleaning member therein and protects the liquid discharge surface of the liquid discharge head;
a cap opening-and-closing unit which opens and closes the cap, the cap opening-and-closing unit opening the cap to move the cleaning member and the cap perpendicularly to the row of the liquid discharge nozzles for the respective types of liquids while the cleaning member is in contact with the liquid discharge surface of the liquid discharge head;
a driving controlling unit which controls the driving of the cap opening-and-closing unit;
a discharge controlling unit which controls a discharge operation of the liquid drops from the liquid discharge nozzles disposed at the liquid discharge surface; and
a platen plate which determines the relationship between the position of the discharge objects and the position of the liquid discharge head by supporting the discharge objects, the platen plate receiving the liquid drops discharged from the liquid discharge head,
wherein,
when the liquid discharge operation on one of the discharge objects is started, the driving controlling unit performs the controlling to open the cap by driving the cap opening-and-closing unit in order to wipe the liquid discharge surface by bringing the cleaning member into contact with and moving the cleaning member along the liquid discharge surface, then the discharge controlling unit performs the controlling to preliminarily discharge the liquid drops to the cap from the liquid discharge nozzles in the order in which the cleaning member passes the row of the liquid discharge nozzles for the respective types of liquids, and then, while the cap is withdrawn from the liquid discharge surface, prior to discharging the liquid onto the discharge object, the discharge controlling unit performs the controlling to preliminarily discharge the liquid drops to the platen plate from the liquid discharge nozzles.

5. The liquid discharger according to claim 4, wherein, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles as a result of the controlling by the discharge controlling unit.

6. The liquid discharger according to claim 4 or claim 5, further comprising a liquid-waste receiver which is disposed at the platen plate and which receives the liquid drops preliminarily discharged from the liquid discharge nozzles.

7. A method for controlling a liquid discharger which discharges liquid drops onto discharge objects from liquid discharge nozzles, the method comprising the step of:
performing controlling such that, when a liquid discharge operation on one of the discharge objects is started, a cap is opened by driving cap opening-and-closing unit in order to wipe a liquid discharge surface by bringing a cleaning member into contact with and moving the cleaning member along the liquid discharge surface, then the liquid drops are preliminarily discharged to the cap from the liquid discharge nozzles after the cleaning member has moved along the liquid discharge surface, and then, while the cap is withdrawn from the liquid discharge surface, prior to discharging the liquid onto the discharge object, the liquid drops are preliminarily discharged to the platen plate from the liquid discharge nozzles,
wherein,
the liquid discharger comprises:
a liquid discharge head having the liquid discharge surface having the liquid discharge nozzles,
the cleaning member which wipes the liquid discharge surface while the cleaning member is in contact with and moves along the liquid discharge surface,
the cap which accommodates the cleaning member therein and protects the liquid discharge surface of the liquid discharge head,
the cap opening-and-closing unit which opens and closes the cap, the cap opening-and-closing unit opening the cap to move the cleaning member and the cap perpendicularly to a row of the liquid discharge nozzles while the cleaning member is in contact with the liquid discharge surface of the liquid discharge head,
a driving controlling unit which controls the driving of the cap opening-and-closing unit,
a discharge controlling unit which controls the discharge operation of the liquid drops from the liquid discharge nozzles disposed at the liquid discharge surface, and
a platen plate which determines the relationship between the position of the discharge objects and the position of the liquid discharge head by supporting the discharge objects, the platen plate receiving the liquid drops discharged from the liquid discharge head.

8. The method according to claim 7, wherein, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles.

9. The method according to claim 7 or claim 8, wherein the liquid discharger further comprises a liquid-waste receiver which is disposed at the platen plate and which receives the liquid drops preliminarily discharged from the liquid discharge nozzles.

10. A method for controlling a liquid discharger which discharges liquid drops onto discharge objects from liquid discharge nozzles, the method comprising the step of:
performing controlling such that, when a liquid discharge operation on one of the discharge objects is started, a cap is opened by driving cap opening-and-closing unit in order to wipe a liquid discharge surface by bringing a cleaning member into contact with and moving the cleaning member along the liquid discharge surface, then the liquid drops are preliminarily discharged to the cap from the liquid discharge nozzles in the order in which the cleaning member passes a row of the liquid discharge nozzles for respective types of liquids disposed at the liquid discharge surface, and then, while the cap is withdrawn from the liquid discharge surface, prior to discharging the liquid onto the discharge object, the liquid drops are preliminarily discharged to the platen plate from the liquid discharge nozzles,
wherein,
the liquid discharger comprises:
a liquid discharge head having the liquid discharge surface having the row of the liquid discharge nozzles for the respective types of liquids,
the cleaning member which wipes the liquid discharge surface while the cleaning member is in contact with and moves along the liquid discharge surface,
the cap which accommodates the cleaning member therein and protects the liquid discharge surface of the liquid discharge head,
the cap opening-and-closing unit which opens and closes the cap, the cap opening-and-closing unit opening the cap to move the cleaning member and the cap perpendicularly to the row of the liquid discharge nozzles for the respective types of liquids while the cleaning member is in contact with the liquid discharge surface of the liquid discharge head,
a driving controlling unit which controls the driving of the cap opening-and-closing unit,
a discharge controlling unit which controls the discharge operation of the liquid drops from the liquid discharge nozzles disposed at the liquid discharge surface, and
a platen plate which determines the relationship between the position of the discharge objects and the position of the liquid discharge head by supporting the discharge objects, the platen plate receiving the liquid drops discharged from the liquid discharge head.

11. The method according to claim 10, wherein, when the liquid drops are to be discharged to more than one of the discharge objects from the liquid discharge nozzles, prior to discharging the liquid onto the second discharge object and/or the subsequent discharge object or objects, while the cap is withdrawn from the liquid discharge surface, the liquid drops are repeatedly preliminarily discharged to the platen plate from the liquid discharge nozzles.

12. The method according to claim 10 or claim 11, wherein the liquid discharger further comprises a liquid-waste receiver which is disposed at the platen plate and which receives the liquid drops preliminarily discharged from the liquid discharge nozzles.
